(19) United States
(12) Patent Application Publication
(10) Pub. No.: US 2008/0081263 A1
(43) Pub. Date: Apr. 3, 2008

(54) Nonaqueous electrolyte secondary battery

(76) Inventors: Keiji Saisho, Osaka (JP); Masato Iwanaga, Osaka (JP); Takeshi Abe, Osaka (JP)

Correspondence Address: KUBOVCIK & KUBOVCIK, SUITE 710, 900 17TH STREET NW, WASHINGTON, DC, 20006, US

(21) Appl. No.: 11/905,095

(22) Filed: Sep. 27, 2007

(30) Foreign Application Priority Data
Sep. 29, 2006 (JP) 267253/2006
Mar. 22, 2007 (JP) 075040/2007

(51) Int. Cl. H01M 10/40

(52) U.S. Cl. 429/338

(57) ABSTRACT

A nonaqueous electrolyte secondary battery is obtained in which a potential of a positive-electrode active material in a fully charged condition is 4.4-4.6 V versus metallic lithium and an Li content of the positive-electrode active material at the potential does not exceed 40% of an initial Li content, and which can show improved cycle characteristics and charge-discharge characteristics. The nonaqueous electrolyte secondary battery includes a positive electrode containing a positive-electrode active material, a negative electrode containing a negative-electrode active material, and a nonaqueous electrolyte, wherein a potential of the positive electrode active material in a fully charged condition is 4.4-4.6 V versus metallic lithium, an Li content of the Positive-electrode active material at the potential does not exceed 40% of the initial Li content, and the nonaqueous electrolyte contains an ethylene carbonate derivative represented by the following structural formula 1 wherein at least one of X and Y is a halogen;

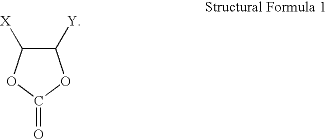

### BACKGROUND OF THE INVENTION

1. Technical Field

The present invention relates to a nonaqueous electrolyte secondary battery and more particularly to a nonaqueous electrolyte secondary battery wherein a potential of a positive electrode active material in a fully charged condition is 4.4-4.6 V versus metallic lithium.

2. Background Art

The recent marked progress of reduction in size and weight of mobile electrical instruments, as well as an increase of their functions, push up power consumption. This has led to an increasing demand for a nonaqueous electrolyte secondary battery, for use as a power source, which has further reduced weight and increased capacity.

As a measure to meet the demand, there is a method which increases a potential of a positive electrode during charge to thereby increase a charge voltage in a lithium secondary battery using lithium cobaltate, a nickel manganese cobalt complex oxide or the like as a positive-electrode active material. As the charge voltage builds up, the amount of Li released from a unit volume of the positive-electrode active material increases. As a result, an energy density of the battery can be increased.

However, the potential build-up of the positive electrode brings a condition where a large amount of Li has been released. Accordingly, a transition metal in the positive-electrode active material increases in electric charge and shifts to a higher valence. Due to the higher valence of the transition metal in the positive-electrode active material, a crystal structure of the positive-electrode active material itself becomes unstable, so that the positive-electrode active material becomes more reactive with an electrolyte solution. This promotes an oxidation reaction of the electrolyte solution on a surface of the positive electrode to cause deterioration of cycle characteristics and battery characteristics during storage in a charged state.

In the case where a positive-electrode active material having an intrinsically high working voltage, such as a spinel compound obtainable by substituting nickel for manganese in lithium manganate, charging is generally performed at a higher positive electrode potential than lithium cobaltate and the like. Japanese Patent Laid-Open No. 2004-241339 describes that, in the case where such a positive-electrode active material having a high working voltage is used, if a fluorine-substituted carbonate such as fluoroethylene carbonate is added, the improved cycle characteristics result.

It is however reported that, when charging is carried out such that the positive electrode potential is at 4.5 V versus metallic lithium, LiNi_{0.5}Mn_{1.5}O₂ used in Japanese Patent Laid-Open No. 2004-241339 releases only about 20% of its initial lithium content, while the lithium cobaltate releases at least 70% of its initial lithium content (Journal of Electrochemical Society, Vol. 141, 2972(1994), Solid State Ionics, Vol. 171, 215 (2004)).

Accordingly, a technology is much expected which can suppress deterioration of cycle characteristics and storage characteristics in a charged state of a secondary battery using lithium cobaltate or the like whose crystal structure becomes unstable when loaded at a high positive electrode potential.

### SUMMARY OF THE INVENTION

It is an object of the present invention to provide a nonaqueous electrolyte secondary battery in which a potential of a positive-electrode active material in a fully charged condition is 4.4-4.6 V versus metallic lithium and an Li content of the positive-electrode active material at the potential does not exceed 40% of an initial Li content, and which can show improved cycle characteristics and charge-discharge characteristics.

The present invention is concerned with a nonaqueous electrolyte secondary battery which has a positive electrode containing a positive-electrode active material, a negative electrode containing a negative-electrode active material and a nonaqueous electrolyte. Characteristically, a potential of the positive-electrode active material in a fully charge condition is 4.4-4.6 V versus metallic lithium, an Li content of the positive-electrode active material at the potential does not exceed 40% of an initial Li content, and the nonaqueous electrolyte contains en ethylene carbonate derivative represented by the following structural formula 1 (in the formula, at least one of X and Y is a halogen).

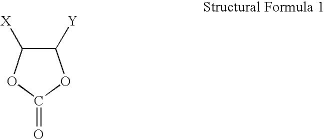

Because a potential of the positive-electrode active material in a fully charge condition is 4.4-4.6 V versus metallic lithium, according to the present invention, a high charge-discharge capacity can be obtained. Also because the above-specified ethylene carbonate derivative is contained in the nonaqueous electrolyte, according to the present invention, a marked deterioration of battery characteristics can be suppressed even if a potential of the positive-electrode active material in a fully charge condition is 4.4-4.6 V versus metallic lithium and an Li content of the positive-electrode active material at the potential does not exceed 40% of an initial Li content. That is, in accordance with the present invention, improved cycle characteristics and storage characteristics in a charged state can be obtained.

In the present invention, an active material comprise of carbon is preferably used as the negative-electrode active material. If the active material comprised of carbon is used as the negative-electrode active material, an effect of a film that is produced via decomposition of the ethylene carbonate derivative can be better obtained. Thus, further improved cycle characteristics can be obtained. A graphite material having a surface coated with amorphous carbon is particularly useful as the active material comprised of carbon. When a product formed as a result of a side reaction at the positive electrode during storage in the charged condition diffuses toward the negative electrode where it reacts, secondary deterioration occurs to cause decline of battery performance characteristics. However, such secondary deterioration can be suppressed if the graphite material having a surface coated with amorphous carbon is used as the negative-electrode active material. Thus, cycle characteristics and storage characteristics in a charged state can be further improved.

The amorphous carbon-coated graphite material can be prepared, for example, by the method which follows. That is, a graphite is mixed with a pitch or the like, which serves as a precursor of the amorphous carbon, to thereby deposit the precursor on a surface of the graphite. Thereafter, the mixture is dried and then ground into a powder. The powder is fired in an inert atmosphere at a temperature that does not allow graphitization of the precursor to proceed, so that the graphite material coated with the amorphous carbon can be prepared.

A core graphite may be obtained such as by firing coke or the like material, or alternatively, by properly pulverizing naturally-yielding graphite or the like to a suitable particle size.

Further, at least one of X and Y in the ethylene carbonate derivative for use in the present invention is preferably fluorine. The use of the ethylene carbonate derivative with at least one of X and Y being a fluorine further retards a reaction on a surface of the positive electrode when charged at a high voltage, resulting in obtaining further improved cycle characteristics and charge-discharge characteristics.

In the present invention, the nonaqueous electrolyte preferably contains the ethylene carbonate derivative in the amount of 0.5-35% by weight, more preferably 2-30% by weight. If the amount of the ethylene carbonate derivative contained is excessively small, film formation on a surface of the negative electrode becomes insufficient, possibly resulting in the failure to sufficiently obtain an effect of the present invention that attains improvements in cycle characteristics and storage characteristics in a charged state. On the other hand, if it is excessively large, a viscosity of the electrolyte solution increases, possibly leading to deterioration of battery characteristics.

Examples of ethylene carbonate derivatives for use in the present invention include 4-fluoro-1,3-dioxolane-2-one, 4-chloro-1,3-dioxolane-2-one, 4-fluoro-4-methyl-1,3-dioxolane-2-one, 4-fluoro-5-methyl-1,3-dioxolane-2-one, 4-chloro-4-methyl-1,3-dioxolane-2-one, 4-chloro-5-methyl-1,3-dioxolane-2-one, 4,5-difluoro-1,3-dioxolane-2-one and 4,5-dichloro-1,3-dioxolane-2-one. The use of 4-fluoro-1,3-dioxolane-2-one and 4,5-difluoro-1,3-dioxolane-2-one, among them, is particularly preferred.

The positive-electrode active material for use in the present invention, while its potential is 4.4-4.6 V versus metallic lithium in a fully charged condition, has an Li content that does not exceed 40% of the initial Li content. The initial Li content can be calculated from a theoretical content of Li in the positive-electrode active material. Also, the Li content of the positive-electrode active material in the fully charged condition, i.e., while its potential is 4.4-4.6 V versus metallic lithium, can be determined from a charge capacity of the positive-electrode active material in the fully charged condition. The charge capacity of the positive-electrode active material in the fully charged condition can be measured, for example, using a three-electrode testing cell in which the use positive electrode constitutes a working electrode and metallic lithium is used for a counter electrode and a reference electrode. More specifically, a theoretical capacity A, on the basis that Li in the positive-electrode active material is totally released, is calculated, a charge capacity B of the positive-electrode active material in the fully charge condition is determined using a three-electrode testing cell, and the Li content (%) of the positive-electrode active material in the fully charged condition, relative to that in the initial condition, is calculated from (A−B)/A.

In the present invention, the Li content of the positive-electrode active material in the fully charged condition is specified not to exceed 40% of the initial content, because of the reason which follows.

When the Li content of the positive-electrode active material in the fully charged condition drops to 40% or less of the initial content, its crystal structure is brought to an unstable state where a bond connecting a transition metal and oxygen becomes relatively susceptible to cleavage and a reaction between the transition metal and an electrolyte solution becomes easy to proceed. Further, as the potential of the positive-electrode active material increases to 4.4 V or above, it comes closer to an oxidative decomposition potential of the electrolyte solution. Then the electrolyte solution becomes more reactive. These factors are combined together to markedly increase reactivity of the positive-electrode active material in the fully charged condition. However, in such a situation, inclusion of the above-specified ethylene carbonate derivative in the nonaqueous electrolyte, in accordance with the present invention, retards an oxidative decomposition reaction of the electrolyte solution to result in obtaining superior cycle characteristics and storage characteristics in a charged state.

The positive-electrode active material applicable in the present invention can be illustrated by lithium-containing transition metal complex oxides such as layered lithium nickel manganese cobalt oxides, representing examples of which include lithium cobaltate (LiCoO₂), lithium nickelate (LiNiO₂) and LiNi_{1/3}Mn_{1/3}Co_{1/3}O₂. These lithium-containing transition metal complex oxides may be substituted with a dissimilar element such as Al, Zr, Ti, Mg, Mo, Fe, Cr, V, or Nb. The amount of the substituting dissimilar element is preferably about 0.01-5% by mole, based on the amount of the transition metal in the lithium-containing transition metal complex oxide used. In the present invention, the above positive-electrode active materials may be used in combination.

Examples of lithium salts for inclusion in the nonaqueous electrolyte in the present invention include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂ and mixtures thereof. Among them, LiBF₄ is particularly preferred for inclusion in the nonaqueous electrolyte. LiBF₄, if included in the nonaqueous electrolyte, decomposes on a surface of a positive electrode in an initial stage of battery construction to lower reactivity at the surface of the positive electrode. As a result, further improved characteristics can be obtained by a synergistic effect of using this lithium salt and the ethylene carbonate derivative.

LiBF₄, if added to the nonaqueous electrolyte, reacts at both surfaces of the positive and negative electrodes to cause a change in surface reactivity of each active material. At the positive electrode side, the reactivity between the positive electrode and the nonaqueous electrolyte decreases to suppress oxidative decomposition of the nonaqueous electrolyte. At the negative electrode side, LiBF₄ reacts with functional groups present at a surface of the active material so that reductive decomposition of the nonaqueous electrolyte can be suppressed particularly under high-temperature conditions.

If the amount of LiBF₄ added is excessively small, the oxidative decomposition suppressing effect at the positive electrode may not be obtained sufficiently. This results in the failure to obtain satisfactory battery characteristics. On the other hand, if the LiBF₄ content is excessively large, the nonaqueous electrolyte may undergo a marked viscosity increase, possibly resulting in deteriorating the battery characteristics. Accordingly, LiBF₄ is preferably contained in the amount of 0.01-1.0 mol/liter.

If LiBF₄ is high in content, its reaction particularly at the negative electrode side proceeds remarkably. While still possible to suppress reductive decomposition of the nonaqueous electrolyte, the presence of excess product of LiBF₄ causes a resistance increase at a surface of the negative-electrode active material. Accordingly, more preferably, LiBF₄ is contained in the amount of 0.01-0.2 mol/liter, particularly preferably 0.05-0.2 mol/liter.

In the present invention, examples of solvents useful in the nonaqueous electrolyte include cyclic carbonates, chain carbonates, lactone compounds (cyclic carboxylate esters), chain carboxylate esters, cyclic ethers, chain ethers and sulfur-containing organic solvents. Preferred among them are cyclic carbonates, chain carbonates, lactone compounds (cyclic carboxylate esters), chain carboxylate esters, cyclic ethers and chain ethers, respectively with a total carbon number of 3-9. In particular, inclusion of one or both of a cyclic carbonate and a chain carbonate, each having a total carbon number of 3-9, is preferred.

In the present invention, a ratio in capacity of the negative electrode to positive electrode is preferably 1.0-2.0, more preferably 1.0-1.3. If this ratio is excessively low, metallic lithium may be deposited on a surface of the negative electrode during charge and discharge. On the other hand, if this ratio is excessively high, a proportion of the negative electrode that takes no part in charge and discharge increases. This may lower a volumetric energy density.

In accordance with the present invention, the nonaqueous electrolyte secondary battery is provided in which a potential of the positive-electrode active material in a fully charged condition is 4.4-4.6 V versus metallic lithium and the Li content of the positive-electrode active material at the potential does not exceed 40% of the initial Li content, and which attains superior cycle characteristics and charge-discharge characteristics.

### BRIEF DESCRIPTION OF THE DRAWINGS

FIG. 1 is a graph which shows a thickness increase of the positive electrode after the storage test at 60° C. for 10 days; and

FIG. 2 is a graph which shows a thickness increase of each of the battery and the positive electrode after the storage test at 60° C. for 10 days.

### DESCRIPTION OF THE PREFERRED EXAMPLES

The present invention is below described in more detail by way of Examples. It will be recognized that the following examples merely illustrate the present invention and are not intended to be limiting thereof. Suitable changes can be effected without departing from the scope of the present invention.

### Experiment 1

(Fabrication of Positive Electrode)

Lithium cobaltate as a positive-electrode active material, ketchen black as a conductive agent, and a fluorine resin as a binder at a ratio by weight of 90:5:5 were mixed. The mixture was dissolved in N-methyl-2-pyrrolidone (NMP) to prepare a paste.

This paste was uniformly applied onto both sides of a 15 μm thick aluminum foil by a doctor blade process. The resultant was subsequently placed in a heated drier where it was subjected to a vacuum heat treatment at a temperature of 100-150° C. to remove NMP, and then rolled by a roll pressing machine to a thickness of 0.13 mm to fabricate a positive electrode for a flat-type laminated battery.

(Fabrication of Negative Electrode)

A negative-electrode active material comprised of graphite, a styrene-butadiene rubber binder and a carboxymethylcellulose viscosity control agent at a ratio by mass of 96:2:2 were mixed. The mixture was dissolved in water to prepare a paste.

This paste was uniformly applied onto both sides of a metal core (10 μm thick copper foil) by a doctor blade process. The resultant was subsequently placed in a heated drier where it was heat treated at a temperature of 100-150° C. to remove water, and then rolled by a roll pressing machine to a thickness of 0.12 mm to fabricate a negative electrode for a flat-type laminated battery.

(Preparation of Electrolyte Solution)

LiPF₆ was dissolved in a solvent containing ethylene carbonate (EC) and diethyl carbonate (DEC) at a 3:7 ratio by volume to a concentration of 1 mole/liter to prepare an electrolyte solution.

Further, vinylene carbonate (VC) or fluoroethylene carbonate (FEC: 4-fluoro-1,3-dioxolane-2-one) was added to the above electrolyte solution in the amount of 2% by mass to prepare an electrolyte solution.

(Construction of Secondary Battery)

The above-fabricated positive and negative electrodes were each cut into a predetermined size. A current collector tab was attached to each of cores of those electrodes. The positive electrode and negative electrode were rolled up with a 20 μm thick, polyolefin microporous film separator between them and fastened by a tape at the outermost periphery to provide a spirally wound electrode assembly which was subsequently pressed in a flat plate configuration.

This spirally wound electrode assembly was inserted into an outer casing comprised of a laminated material of PET, aluminum and others such that an end of each electrode tab extended outwardly from the assembly. After introduction of the above-prepared electrolyte solution, the outer casing was sealed to build a secondary battery.

Before completion of the battery, the electrode assembly was placed in a closed container and suction dried to remove water from the active materials and the separator. Also, the ratio, (negative electrode capacity)/(positive electrode capacity), was set at 1.10. The constructed battery exhibited a discharge capacity of 700 mAh in all cases where the different electrolyte solutions were used.

According to the above procedure, the batteries of Example 1 and Comparative Examples 1 and 2 were constructed, as shown in Table 1.

TABLE 1

| | Negative-Electrode | Electrolyte | |
|---|---|---|---|
| | Active Material | Salt | Additive |
| Comparative Example 1 | Graphite | 1.0M LiPF₆ | None |
| Comparative Example 2 | | | VC2% |
| Example 1 | | | FEC2% |

(Evaluation of Charge-Discharge Characteristics)

The batteries of Example 1 and Comparative Examples 1 and 2 were each charged at a charge current of 700 mA to a battery voltage of 4.38 V, further charged at a constant voltage of 4.38 V to a current value of 35 mA and then discharged at a current of 700 mA to a battery voltage of 2.75 V. This charge-discharge unit cycling was repeated.

A capacity retention of each battery after 300 charge-discharge cycles under the above conditions is shown in the following Table 2. The capacity retention, as used herein, refers to a value given by (300th cycle discharge capacity)/(1st cycle discharge capacity).

The potential of the positive electrode in the fully charged battery was about 4.48 V versus metallic lithium, for all the batteries. The Li content of the positive-electrode active material in the fully charged condition was determined according to the following procedure.

LiCoO₂, serving as the positive-electrode active material, is 1/97.82 mol per gram. Thus, a theoretical capacity when Li in the positive-electrode active material is totally released is given by

$$( 1 / 97.82 ( mol \text{/} g ) ) \times ( 9.648 \times {10}^{4} ( C \text{/} mol ) ) \times ( 1 / 3600 ( h \text{/} s ) ) = 0.274 ( C \cdot h \text{/} g \cdot s ) = 0.274 Ah \text{/} g = 274 mAh \text{/} g .$$

In order to determine a charge capacity of the positive-electrode active material in the fully charged condition, a three-electrode test cell using the positive electrode was built. The charge capacity was determined by charging the cell until the potential of the positive electrode reached 4.48 V. As a result, the charge capacity per gram of the active material was 194 mAh/g and the amount of Li remaining in the positive-electrode active material was 80 mAh/g in terms of charge capacity. Accordingly, the amount of Li remaining in the positive-electrode active material in the fully charged condition is (80/274)×100=29.1% of the initial amount of Li. Therefore, the Li content of the positive-electrode active material in the fully charged condition was confirmed to be about 30% of the initial Li content.

(Evaluation of Storage Characteristics in Charged State)

Also, the batteries of Example 1 and Comparative Examples 1 and 2 were each evaluated for storage characteristics in a charged state. Each battery was charged at a current of 700 mA to a battery voltage of 4.38 V, further charged at a constant voltage of 4.38 V to a current value of 35 mA and then discharged at a current of 700 mA to a battery voltage of 2.75 V to confirm a discharge capacity. Thereafter, the battery was fully charged under the same conditions as above. Each battery in the fully charged condition was stored in a constant temperature chamber at 60° C. for 15 days. After storage, a thickness increase of each battery was measured. The measurement results are shown in Table 2.

TABLE 2

| | | Thickness Increase |
|---|---|---|
| | Capacity Retention | of Battery |
| | after 300 | after Stored in |
| | Charge-Discharge | Charged Condition |
| | Cycles | at 60° C. for 15 Days |
| Comparative Example 1 | 87% | 0.49 mm |
| Comparative Example 2 | 91% | 2.87 mm |
| Example 1 | 91% | 0.57 mm |

As shown in Table 2, the battery of Comparative Example 1, which contains no additives in its electrolyte solution, is less susceptible to thickness increase due to gas generation during storage in the charged state but shows inferior charge-discharge cycle characteristics. Also, the battery of Comparative Example 2, which uses VC as an additive, exhibits good charge-discharge cycle characteristics but shows a marked thickness increase due to gas generation during storage in the charged state. To the contrary, the battery of Example 1, which uses FEC as an additive according to the present invention, has been found to be less susceptible to thickness increase due to gas generation during storage in the charged state and also show superior cycle characteristics.

The following is believed to explain the difference in action and effect between VC and FEC.

That is, the use of VC as an additive results in the formation of an SEI (Solid Electrolyte Interface) on the negative electrode and makes it possible to obtain good cycle characteristics. However, VC readily decomposes oxidatively at the positive electrode side and generates a large amount of gas particularly when the positive electrode is in the high potential condition. FEC, if used as an additive, not only forms a good film on the negative electrode in a manner similar to VC to improve cycle characteristics, but also retards a reaction at the positive electrode side to reduce the amount of gas generated due to oxidative decomposition at the positive electrode.

The battery, when stored in the charged condition at high temperature, generates a larger amount of gas than when stored in the non-charged condition. Also, analysis of a surface of the negative electrode after high-temperature storage resulted in detection of a reaction product due to oxidative composition at the positive electrode. These are believed to suggest that, in a nonaqueous electrolyte secondary battery having a high-potential positive electrode and a negative electrode, two reactions, i.e., an oxidative decomposition reaction at the positive electrode side and a secondary reaction wherein a side reaction product associated with the positive electrode reacts at a surface of the negative electrode, provide a significant effect on deterioration of characteristics of the battery while stored in the charged condition.

For a comparative purpose, a battery was built such that its end-of-charge voltage was 4.2 V, i.e., it was brought to a fully charged condition where a potential of the positive electrode was 4.3 V. Cycle characteristics and storage characteristics in a charged state were evaluated in the same manner as described above. The Li content in the fully charged condition is about 45% of the initial Li content. In either case where VC or FEC was added, this battery showed superior cycle characteristics and storage characteristics in a charged state. However, because of a discharge capacity decline of about 15%, a marked reduction of energy density occurs for the battery.

The stability of the electrolyte solution at a high potential depends essentially on the oxidation resistance of the solvent used for the electrolyte solution. However, the decomposition reaction of the electrolyte solution starts to occur at a lower potential when LiCoO₂ or the like is used than when a low active platinum electrode or the like is used. This is because the reactivity of the electrode as a reaction field strongly influences the oxidative decomposition reaction.

Therefore, even in the case where the battery is charged to the same potential, the positive electrode becomes more reactive with the electrolyte solution when a transition metal is in a higher valence state or when a higher proportion of a transition metal is in a high valence state. Accordingly, gas generation due to oxidative decomposition of the electrolyte solution proceeds more remarkably when a positive electrode material capable of releasing more Li, such as LiCoO₂ or LiNi_{1/3}Mn_{1/3}Co_{1/3}O₂, is used as the positive-electrode active material. The use of a low reactive halogenated ethylene carbonate derivative, in accordance with the present invention, results in obtaining good storage characteristics while maintaining superior cycle characteristics.

### Experiment 2

The procedure of Example 1 was followed, except that the additives and electrolyte salts specified in Table 3 were used, to build batteries of Examples 2 and 3. Table 3 also shows the corresponding components used in the battery of Example 1.

TABLE 3

| | | Negative-Electrode | |
|---|---|---|---|
| | Additive | Active Material | Electrolyte Salt |
| Example 1 | FEC2% | Graphite | 1.0M LiPF₆ |
| Example 2 | | | 0.8M LiPF₆ + 0.2M LiBF₄ |
| Example 3 | | | 1.0M LiPF₆ + 0.2M LiBF₄ |

(Evaluation of Storage Characteristics in Charged State)

Each of the batteries built in Examples 1-3 was charged at a current of 700 mA to a battery voltage of 4.38 V, further charged at a constant voltage of 4.38 V to a current value of 35 mA and then discharged at a current of 700 mA to a battery voltage of 2.75 V to confirm a discharge capacity. Thereafter, the battery was fully charged under the same conditions as used above. The battery in the fully charged condition was stored in a constant temperature chamber at 60° C. for 20 days. After storage, the battery was discharged under the same conditions as above, followed by a cycle of charge and discharge. A capacity restoration of each battery after 20 days' storage was shown in the following Table 4. The capacity restoration, as used herein, is a value given by (discharge capacity in the charge-discharge cycle subsequent to storage in the charged state)/(discharge capacity in the charge-discharge cycle prior to storage).

TABLE 4

| | Capacity Restoration of Battery |
|---|---|
| | after Stored in Charged Condition |
| | at 60° C. for 15 Days |
| Example 1 | 70.7% |
| Example 2 | 76.2% |
| Example 3 | 75.5% |

As can be clearly seen from comparison between the battery of Example 1 which do not contain LiBF₄ in its electrolyte solution and the batteries of Examples 2 and 3 which contains LiBF₄ in their electrolyte solutions, the inclusion of LiBF₄ in the electrolyte solution improves the capacity restoration of the battery after storage in the charged state. The detailed reason why the capacity restoration of the battery after storage in the charged state is improved is not clear. It is however assumed that LiBF₄ in an initial condition decomposes at a surface of the positive-electrode active material to change a surface condition of the positive-electrode active material in such a way as to lower its reactivity with the electrolyte solution.

### Experiment 3

The procedure of Example 1 was followed, except that the negative-electrode active materials, electrolyte salts and additives specified in Table 5 were used, to build batteries of Examples 4-8 and Comparative Example 3. Table 5 also shows the corresponding components used in the batteries of Examples 2 and 3. The amorphous carbon-coated graphite was made using graphite and a pitch. The coated amorphous carbon was 1% by weight.

TABLE 5

| | Negative- | | |
|---|---|---|---|
| | Electrode | | Type and |
| | Active | | Concentration |
| | Material | Electrolyte Salt | of Additive |
| Comparative | Graphite | 0.8M LiPF₆ + 0.2M LiBF₄ | VC2% |
| Example 3 | | | |
| Example 2 | | | FEC2% |
| Example 3 | | 1.0M LiPF₆ + 0.2M LiBF₄ | |
| Example 4 | | | FEC5% |
| Example 5 | Amorphous | 0.8M LiPF₆ + 0.2M LiBF₄ | FEC2% |
| Example 6 | Carbon- | 1.0M LiPF₆ + 0.2M LiBF₄ | |
| Example 7 | Coated | 1.2M LiPF₆ + 0.2M LiBF₄ | |
| Example 8 | Graphite | 1.0M LiPF₆ + 0.2M LiBF₄ | FEC5% |

(Evaluation of Charge-Discharge Cycles)

The batteries of Example 2-8 and Comparative Example 3 were each charged at a charge current of 700 mA to a battery voltage of 4.38 V, further charged at a constant voltage of 4.38 V to a current value of 35 mA and then discharged at a current of 700 mA to a battery voltage of 2.75 V. This charge-discharge unit cycling was repeated. The potential of the positive electrode in each battery in the fully charged condition was confirmed to be about 4.48 V versus metallic lithium.

A capacity retention of each battery after 200 charge-discharge cycles under the above conditions is shown in the following Table 6. The charge retention, as used herein, is a value given by (200th cycle discharge capacity)/(1st cycle discharge capacity).

(Evaluation of Storage Characteristics in Charged State)

Each of the batteries of Example 2-8 and Comparative Example 3 was charged at a current of 700 mA to a battery voltage of 4.38 V, further charged a constant voltage of 4.38 V to a current value of 35 mA and then discharged at a current of 700 mA to a battery voltage of 2.75 V to confirm a discharge capacity. Thereafter, the battery was fully charged under the same conditions as described above. Each battery in the fully charged condition was stored in a constant temperature chamber at 60° C. for 15 days. A thickness increase of each battery after 15 days' storage is shown in the following Table 6.

TABLE 6

| | | Thickness Increase of Battery |
|---|---|---|
| | Capacity Retention | after Stored in |
| | after 300 | Charged Condition |
| | Charge-Discharge Cycles | at 60° C. for 15 Days |
| Comparative | 89% | 7.10 mm |
| Example 3 | | |
| Example 2 | 88% | 2.19 mm |
| Example 3 | 89% | 1.82 mm |
| Example 4 | 89% | 1.76 mm |
| Example 5 | 87% | 1.20 mm |
| Example 6 | 89% | 1.12 mm |
| Example 7 | 89% | 0.83 mm |
| Example 8 | 88% | 1.06 mm |

As shown in Table 6, with regard to a capacity retention after 200 cycles, all the batteries similarly show good characteristics. However, the battery of Comparative Example 3, which uses graphite as the negative-electrode active material and VC as the additive, shows a marked thickness increase during storage in the charged condition. Also, the batteries of Examples 2-4, which use FEC as the additive, show relatively large values for thickness increase.

To the contrary, the batteries of Examples 5-7, which use a amorphous carbon-coated graphite as the negative-electrode active material and 2% FEC as the additive, each show a smaller thickness increase, compared to the batteries of Examples 2 and 3 which use a graphite positive electrode. Also, the battery of Example 8, in which FEC is increased to 5%, shows a smaller thickness increase, compared to the battery of Example 4.

The use of FEC as the additive improves charge-discharge cycle characteristics and suppresses oxidative decomposition at the positive electrode side during charge and discharge. However, the use of the graphite material having a surface coated with amorphous carbon as the negative-electrode active material is believed to have retarded a secondary reaction of the side reaction product formed as a result of oxidative decomposition at the positive electrode side and accordingly enabled a marked improvement of storage characteristics. Also, the degree of oxidative decomposition at the positive electrode side increases in dependence on the potential of the positive electrode and the depth of charge of the positive-electrode active material. Accordingly, the above effect becomes greater particularly in the battery in which the positive electrode is capable of high potential.

Also, the negative electrode using the active material consisting solely of amorphous carbon has a higher potential in the charged condition, relative to using graphite, and thus lowers a battery voltage. This, as a result, lowers an energy density of the battery. The use of the graphite coated with amorphous carbon enables provision of a nonaqueous electrolyte secondary battery which shows superior cycle characteristics and good storage characteristics in the charged state without experiencing an energy density decline due to working voltage drop. The amorphous carbon is preferably contained in the amorphous carbon-coated graphite material in the amount of 0.05-5% by weight.

### Experiment 4

A cylindrical battery was constructed according to the following procedures.

(Fabrication of Positive Electrode)

Instead of using lithium cobaltate alone, a mixture of layered nickel manganese lithium cobaltate (LiNi_{1/3}Mn_{1/3}Co_{1/3}O₂) and lithium cobaltate at a 1:9 ratio by mass was used as the positive-electrode active material. The paste was rolled to a thickness of 0.14 mm. Otherwise, the procedure used above to fabricate the positive electrode for a flat laminated battery was followed to fabricate a positive electrode for a cylindrical battery.

(Fabrication of Negative Electrode)

The coating weight of the paste was suitably altered such that the ratio in initial charge capacity per unit area of the negative electrode to the opposing positive electrode was brought to 1.10. Also, the thickness of the paste was suitably adjusted such that the loading density of the active material remained unchanged. Otherwise, the procedure used above to fabricate the negative electrode for a flat laminated battery was followed to fabricate a negative electrode for a cylindrical battery.

(Preparation of Electrolyte Solution)

Ethylene carbonate (EC), dimethyl carbonate (DMC) and methylethyl carbonate (MEC) in the ratio by volume of 20/40/40 were blended to prepare a solvent. This solvent was used as a “FEC-free” electrolyte solution. Also, a blend in the FEC/DMC/MEC volume ratio=20/40/40 was prepared and designated as a “20% FEC” electrolyte solution. Accordingly, the “20% FEC” means 20% by volume of FEC. Further, a blend in the FEC/DMC/MEC volume ratio=40/30/30 was prepared and designated as a “40% FEC” electrolyte solution. In the preparation of each electrolyte solution, LiPF₆ as an electrolyte salt was dissolved in the blend to a concentration of 1 mol/liter.

(Construction of Secondary Battery)

The above-fabricated positive and negative electrodes were each cut into a predetermined size. A current collector tab was attached to each of cores thereof. These electrodes were rolled up with a 18 μm thick, polyolefin microporous film separator between them to make an electrode assembly. This electrode assembly, together with an insulation plate, were then inserted in an exterior can. Thereafter, a negative current collector tab was welded to a bottom of the exterior can.

Subsequently, an explosion-proof valve, a PTC element and a terminal cap were caulkingly fastened through an inner gasket to a sealing plate to make a sealed interior. Thereafter, a positive current collector tab was welded to a top sealing plate. After the electrolyte solution prepared according to the above procedure was poured in the exterior can, the top sealing plate was caulk-fastened through an outer gasket to an open end of the exterior can to complete construction of a battery. The battery when charged to and at 4.35 V exhibited a discharge capacity of 2,800 mAh in all cases where different electrolyte solutions was used.

In the manner as described above, the batteries of Examples 9 and 10 and Comparative Examples 4-6, as shown in Table 7, were constructed.

TABLE 7

| | Battery Configuration | Voltage | Additive |
|---|---|---|---|
| Comparative | Cylindrical | 4.35 V | FEC-Free |
| Example 4 | | | |
| Example 9 | | | FEC20% |
| Example 10 | | | FEC40% |
| Comparative | | 4.20 V | FEC-Free |
| Example 5 | | | |
| Comparative | | | FEC20% |
| Example 6 | | | |

(Evaluation of Charge-Discharge Cycles)

The batteries of Examples 9 and 10 and Comparative Examples 4-6 were each charged at a charge current of 1,000 mA to a battery voltage of 4.35 V or 4.20 V, further charged at a constant voltage of 4.35 V or 4.20 V to a current value of 54 mA and then discharged at a current of 2,700 mA to a battery voltage of 2.75 V. This charge-discharge unit cycling was repeated to achieve 300 cycles. A capacity retention of each battery after 300 cycles was shown in Table 8.

The Li content of the positive-electrode active material in a fully charged condition was 32% in case of the battery voltage of 4.35 V (positive electrode potential of 4.45 V) or 41% in case of the battery voltage of 4.20 V (positive electrode potential of 4.30 V), each based on the initial Li content.

TABLE 8

| | Capacity Retention |
|---|---|
| Comparative Example 4 | 61% |
| Example 9 | 75% |
| Example 10 | 65% |
| Comparative Example 5 | 85% |
| Comparative Example 6 | 73% |

As shown in Table 8, between the batteries of Comparative Examples 5 and 6 which were both charged to and at 4.20 V, the FEC-containing battery of Comparative Example 6 showed inferior cycle characteristics. However, among the batteries of Comparative Example 4 and Examples 9 and 10 which were all charged to and at 4.35 V, the FEC-containing batteries of Examples 9 and 10 showed superior charge-discharge cycle characteristics to the battery of Comparative Example 4. However, between the 20% FEC battery of Example 9 and the 40% FEC battery of Example 10, the 40% FEC battery of Example 10 showed inferior cycle characteristics. The detail of what caused the above results is not clear, but the following is assumed to explain it.

That is, in case of a low positive electrode potential (low battery voltage), Li is consumed due to a reaction of FEC. The battery then shows inferior cycle characteristics, relative to the FEC-free battery. On the other hand, in case of a high positive electrode potential, oxidative decomposition of the electrolyte solution at the positive electrode side occurs increasingly with charge-discharge cycling. In addition, a decomposition product formed at the positive electrode side moves toward the negative electrode side where it undergoes a side reaction. These deteriorate battery characteristics.

In the case where FEC is added to the electrolyte solution, while Li consumption occurs due to decomposition of FEC, not only oxidative decomposition of the electrolyte solution at the positive electrode but also the side reaction at the negative electrode are suppressed to retard progress of deterioration. As a result, a marked improvement of cycle characteristics can be achieved.

However, if FEC is added in an excessively large amount, a viscosity of the electrolyte solution increases remarkably. This is believed to cancel the cycle improvement effect of FEC and result in the failure to obtain the cycle improvement effect sufficiently.

### Experiment 5

The electrolyte solution specified in Table 9 was used. Also, a coating weight of the positive paste was adjusted such that the amount of Li released from the positive electrode remained unchanged when the battery was charged to the voltage specified in Table 6. Otherwise, the procedure of Example 1 was followed to construct batteries of Example 11 and Comparative Examples 7-9.

As shown in Table 9, the positive electrode potential is about 4.30 V when the battery voltage is 4.2 V and about 4.50 V when the battery voltage is 4.4 V.

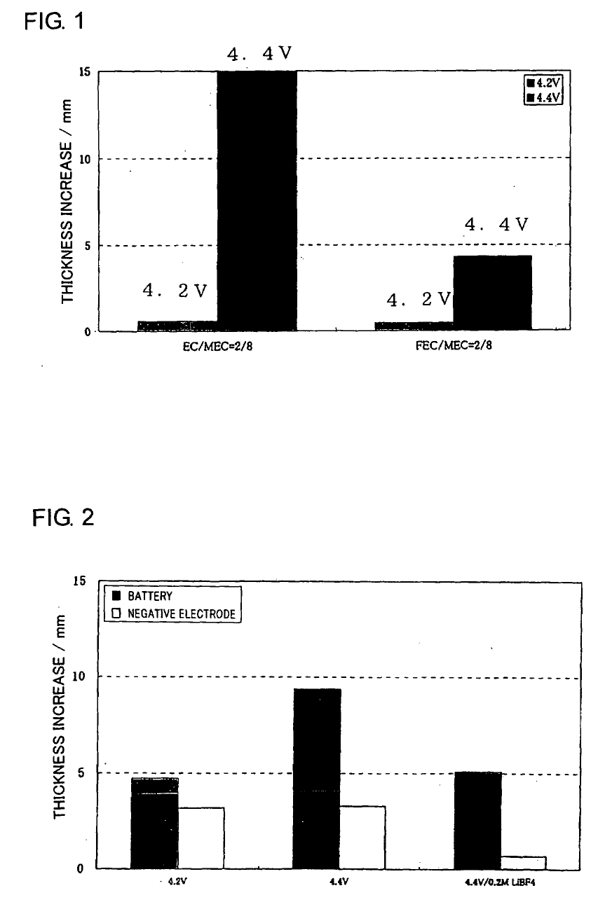

Each of the batteries of Example 11 and Comparative Examples 7-9 was charged at a current of 700 mA to the battery voltage specified in Table 9, further charged at the same voltage to a current value of 35 mA and then discharged at a current of 700 mA to a battery voltage of 2.75 V. The battery was thereafter fully charged under the same conditions as described above. The battery in the fully charged condition was disassembled under an argon (Ar) atmosphere. Only the positive electrode was removed to measure its thickness. This positive electrode was again encapsulated in a laminated aluminum case, stored in a constant-temperature tank at 60° C. for 10 days and then measured for thickness. The thickness increase of the positive electrode in this storage test is shown in Table 9. FIG. 1 also shows the thickness increase of the positive electrode.

TABLE 9

| | | | Thickness |
|---|---|---|---|
| | Battery Voltage | | Increase of |
| | (Positive Electrode | | Positive |
| | Potential) | Electrolyte Solution | Electrode |
| Comparative | 4.2 V (about 4.30 V) | 1.0M LiPF₆ | 1.7 mm |
| Example 7 | | EC/MEC = 2/8 | |
| Comparative | 4.4 V (about 4.50 V) | | 15.0 mm |
| Example 8 | | | |
| Comparative | 4.2 V (about 4.30 V) | 1.0M LiPF₆ | 1.4 mm |
| Example 9 | | FEC/MEC = 2/8 | |
| Example 11 | 4.4 V (about 4.50 V) | | 6.5 mm |

As shown in Table 9 and FIG. 1, in the batteries of Comparative Examples 7 and 9 which were charged to a battery voltage of 4.2 V (positive electrode potential of about 4.30 V), little thickness increase occurs in the positive electrode, irrespective of the type of the electrolyte solution. However, in the FEC (4-fluoroethylene carbonate)-free battery of comparative Example 8 which was charged to a battery voltage of 4.4 V (positive electrode potential of about 4.50 V), a very large amount of gas was generated and significant thickness increase occurred. Some samples of Comparative Example 8 were left out of encapsulation by the laminated aluminum.

To the contrary, the FEC-containing battery of Example 11 generated a smaller amount of gas and showed smaller thickness increase of the positive electrode, compared to the battery of Comparative Example 8.

As described above, when charging was carried out in the positive electrode potential range of higher than 4.4 V versus metallic lithium, the positive electrode increase reactivity with the electrolyte solution and generates a large amount of gas, even in the case of using ethylene carbonate which, at a low voltage, little generated a gas via a reaction with the positive electrode. However, the inclusion of halogenated ethylene carbonate, in accordance with the present invention, has been found to assure superior storage characteristics even in the case where the positive electrode is used in a high potential condition.

### Experiment 6

The electrolyte solution specified in Table 10 was used. Also, a coating weight of the positive paste was adjusted such that the amount of Li released from the positive electrode remained unchanged when the battery was charged to the voltage specified in Table 10. Otherwise, the procedure of Example 1 was followed to build batteries of Examples 13 and 14 and Comparative Example 10.

Here, the positive electrode potential is about 4.30 V when the battery voltage is 4.2 V and about 4.50 V when the battery voltage is 4.4 V.

Each of the batteries of Examples 13 and 14 and Comparative Example 10 was charged at a current of 700 mA to the battery voltage specified in Table 10, further charged at the same voltage to a current value of 35 mA and then discharged at a current of 700 mA to a battery voltage of 2.75 V. The battery was thereafter fully charged under the same conditions as described above.

For each of those batteries in the fully charged condition, two sample batteries were prepared. One sample battery was disassembled under an argon (Ar) atmosphere and only the negative electrode was removed. This negative electrode was again encapsulated in a laminated aluminum case. This negative electrode while encapsulated in the laminated aluminum case, together with the other sample battery in the fully charged condition, were subjected to a storage test at 60° C. for 10 days. Specifically, the negative electrode alone while encapsulated in the laminated aluminum case and the battery in the fully charged condition were both stored in a constant-temperature chamber at 60° C. for 10 days. A thickness increase of the battery before and after storage, as well as a thickness increase of the negative electrode before and after storage, were measured. The measurement results are shown in Table 10. FIG. 2 also shows the measurement results.

TABLE 10

| | Battery Voltage | | Thickness | Thickness |
|---|---|---|---|---|
| | (Positive | | Increase | Increase of |
| | Electrode | Electrolyte | of | Negative |
| | Potential) | Solution | Battery | Electrode |
| Comparative | 4.2 V | 1.0M LiPF₆ | 4.7 mm | 3.2 mm |
| Example 10 | (about 4.30 V) | FEC/MEC = | | |
| | | 2/8 | | |
| Example 13 | 4.4 V | | 9.4 mm | 3.3 mm |
| Example 14 | (about 4.50 V) | 1.0M LiPF₆ + | 5.1 mm | 0.7 mm |
| | | 2.0M LiBF₄ | | |
| | | FEC/MEC = | | |
| | | 2/8 | | |

As shown in Table 10 and FIG. 2, the battery of Example 13 using an end-of-voltage of 4.4 V shows a thickness increase of the negative electrode that is comparable in value to that of the battery of Comparative Example 10 using an end-of-voltage of 4.2 V, but itself shows a much larger thickness increase than the battery of Comparative Example 10 because of a large amount of gas generated at the positive electrode side.

The battery of Example 14, which contains LiBF₄ in its electrolyte solution, shows a smaller thickness increase of the negative electrode than the battery of Example 13 and shows marked reduction in amount of a gas generated at the negative electrode side. As a result, it shows a battery thickness increase comparable in value to the battery of Comparative Example 10.

It is understood from the foregoing that when the battery in the fully charged condition is stored under a constant-temperature atmosphere, a reaction accompanied by gas generation takes place at both of the positive and negative electrodes, resulting in the thickness increase of the battery. At the positive electrode side, gas generation is believed to occur as a result of a reaction of the high-potential positive electrode with the electrolyte solution that causes oxidative decomposition of the electrolyte solution to proceed. At the negative electrode side, gas generation is believed to occur due to decomposition under a high-temperature environment of a film initially formed on a surface of the negative electrode.

It is also understood from the foregoing that when the battery is charged in a condition where a positive electrode potential is high, the use of halogenated ethylene carbonate retards a reaction involving gas generation at the positive electrode side, relative to using no halogenated ethylene carbonate. However, even in the case where halogenated ethylene carbonate is used, the amount of gas generated at the positive electrode side increases with build-up of the positive electrode potential, resulting in increasing a battery thickness. It is believed that LiBF₄, when added to the electrolyte solution, decomposes at a surface of the negative electrode in an initial stage of charge-discharge to thereby suppress decomposition of halogenated ethylene carbonate at the negative electrode side and accordingly reduce the amount of gas generated due to the decomposition thereof. This is believed to reduce the amount of gas generated in the battery as a whole and accordingly suppress increase in amount of a gas generated due to voltage build-up.

1. A nonaqueous electrolyte secondary battery comprising a positive electrode containing a positive-electrode active material, a negative electrode containing a negative-electrode active material, and a nonaqueous electrolyte,
wherein a potential of said positive electrode active material in a fully charged condition is 4.4-4.6 V versus metallic lithium, an Li content of the positive-electrode active material at the potential does not exceed 40% of the initial Li content, and said nonaqueous electrolyte contains an ethylene carbonate derivative represented by the following structural formula 1 wherein at least one of X and Y is a halogen;

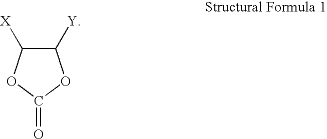

2. The nonaqueous electrolyte secondary battery as recited in claim 1, wherein an active material comprised of carbon is used as said negative-electrode active material.

3. The nonaqueous electrolyte secondary battery as recited in claim 2, wherein a graphite material having a surface coated with amorphous carbon is used as said negative-electrode active material.

4. The nonaqueous electrolyte secondary battery as recited in claim 1, wherein at least one of X and Y in said ethylene carbonate derivative is fluorine.

5. The nonaqueous electrolyte secondary battery as recited in claim 4, wherein said ethylene carbonate derivative is 4-fluoroethylene carbonate.

6. The nonaqueous electrolyte secondary battery as recited in claim 1, wherein said ethylene carbonate derivative is contained in the nonaqueous electrolyte in the amount of 0.5-35% by weight.

7. The nonaqueous electrolyte secondary battery as recited in claim 1, wherein said positive-electrode active material is at least one selected from lithium cobaltate, lithium nickelate, layered lithium nickel manganese cobalt oxide, and compounds obtainable by adding a dissimilar element to them.

8. The nonaqueous electrolyte secondary battery as recited in claim 1, wherein said nonaqueous electrolyte contains LiBF₄.

9. The nonaqueous electrolyte secondary battery as recited in claim 2, wherein at least one of X and Y in said ethylene carbonate derivative is fluorine.

10. The nonaqueous electrolyte secondary battery as recited in claim 9, wherein said ethylene carbonate derivative is 4-fluoroethylene carbonate.

11. The nonaqueous electrolyte secondary battery as recited in claim 2, wherein said ethylene carbonate derivative is contained in the nonaqueous electrolyte in the amount of 0.5-35% by weight.

12. The nonaqueous electrolyte secondary battery as recited in claim 2, wherein said positive-electrode active material is at least one selected from lithium cobaltate, lithium nickelate, layered lithium nickel manganese cobalt oxide, and compounds obtainable by adding a dissimilar element to them.

13. The nonaqueous electrolyte secondary battery as recited in claim 2, wherein said nonaqueous electrolyte contains LiBF₄.

14. The nonaqueous electrolyte secondary battery as recited in claim 3, wherein at least one of X and Y in said ethylene carbonate derivative is fluorine.

15. The nonaqueous electrolyte secondary battery as recited in claim 14, wherein said ethylene carbonate derivative is 4-fluoroethylene carbonate.

16. The nonaqueous electrolyte secondary battery as recited in claim 3, wherein said ethylene carbonate derivative is contained in the nonaqueous electrolyte in the amount of 0.5-35% by weight.

17. The nonaqueous electrolyte secondary battery as recited in claim 3, wherein said positive-electrode active material is at least one selected from lithium cobaltate, lithium nickelate, layered lithium nickel manganese cobalt oxide, and compounds obtainable by adding a dissimilar element to them.

18. The nonaqueous electrolyte secondary battery as recited in claim 3, wherein said nonaqueous electrolyte contains LiBF₄.

19. The nonaqueous electrolyte secondary battery as recited in claim 4, wherein said ethylene carbonate derivative is contained in the nonaqueous electrolyte in the amount of 0.5-35% by weight.

20. The nonaqueous electrolyte secondary battery as recited in claim 4, wherein said positive-electrode active material is at least one selected from lithium cobaltate, lithium nickelate, layered lithium nickel manganese cobalt oxide, and compounds obtainable by adding a dissimilar element to them.
